(19) United States
(12) Patent Application Publication
(10) Pub. No.: US 2015/0189222 A1
(43) Pub. Date: Jul. 2, 2015

(54) CONTENT-ADAPTIVE CHUNKING FOR DISTRIBUTED TRANSCODING

(71) Applicant: Google Inc., Mountain View, CA (US)

(72) Inventors: Sam John, Fremont, CA (US); Sang-Uok Kum, Sunnyvale, CA (US); Steve Benting, San Mateo, CA (US); Thierry Foucu, San Jose, CA (US); Yao-Chung Lin, Sunnyvale, CA (US)

(73) Assignee: Google Inc., Mountain View, CA (US)

(21) Appl. No.: 14/144,331

(22) Filed: Dec. 30, 2013

(51) Int. Cl. H04N 5/91

(52) U.S. Cl. CPC H04N 5/91

(57) ABSTRACT

A system and method are disclosed for transcoding a video clip. In one implementation, a computer system determines N frames at which to divide a video clip into N+1 consecutive chunks, where N is a positive integer, and where the frames are determined based on the image content of the video clip, a minimum chunk size, and a maximum chunk size. Each of the N+1 chunks is provided to a respective processor for transcoding, and a transcoded video clip is generated from the transcoded N+1 chunks.

### TECHNICAL FIELD

Aspects and implementations of the present disclosure relate to data processing, and more specifically, to transcoding of digital content.

### BACKGROUND

Transcoding is the direct digital-to-digital data conversion of one encoding to another. Transcoding is often utilized in the delivery of video clips to client machines (e.g., desktop computers, smartphones, tablets, etc.) to provide support for various screen resolutions, aspect ratios, file formats, codecs, etc.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

In an aspect of the present disclosure, a computer system determines N frames at which to divide a video clip into N+1 consecutive chunks, where N is a positive integer, and where the frames are determined based on the image content of the video clip, a minimum chunk size, and a maximum chunk size. In one implementation, each of the N+1 chunks are provided to a respective processor for transcoding, and a transcoded video clip is then generated from the transcoded N+1 chunks.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts a portion of an illustrative video clip and illustrative fixed-size and content-adaptive chunking of the video clip.

FIG. 2 illustrates an exemplary system architecture, in accordance with one implementation of the present disclosure.

FIG. 3 is a block diagram of one implementation of a transcoding manager.

FIG. 4 depicts a flow diagram of aspects of a method for distributed transcoding of video clips.

FIG. 5 depicts a flow diagram of aspects of a method for determining boundary frames at which to divide video into chunks.

FIG. 6 depicts a block diagram of an illustrative computer system operating in accordance with aspects and implementations of the present disclosure.

### DETAILED DESCRIPTION

Aspects and implementations of the present disclosure are disclosed for distributed transcoding of video clips. In particular, implementations of the present disclosure are capable of dividing a video clip into chunks, providing each of the chunks to a respective processor for transcoding (e.g., a central processing unit of a respective server, a respective processor of a multi-processor computer, etc.), and generating a transcoded video clip from the transcoded chunks. Because the chunks can be transcoded in parallel by the processors, the video clip can be transcoded in a fraction of the time required for a single processor transcoding the entire video clip.

A problem that may arise with such a strategy, however, is that chunks can vary widely in their video coding complexity. More particularly, when a scene is split across adjacent chunks having different video coding complexities, the result can be discontinuities at chunk boundaries that, when large enough, can be visible to a viewer of the transcoded video clip. For example, there may be a discontinuity in quantization step size between adjacent chunks that, when large enough, causes a visible discontinuity in peak signal-to-noise ratio (PSNR) at the chunk boundary.

A further problem when using chunking to transcode video arises from the nature of video compression. More particularly, video compression utilizes different types of frames—I-frames containing fully-specified images, and non-I-frames that store only changes between adjacent frames (e.g., predicted picture frames known as P-frames, bi-predictive picture frames known as B-frames, etc.). While the first frame of a chunk is always an I-frame, the final frame of a chunk may be either an I-frame or a non-I-frame. Moreover, I-frames and non-I-frames exhibit different quantization noise patterns. Consequently, the quality difference between a final non-I-frame of a chunk and the initial I-frame of the next chunk can result in a visible flicker known as I-pulsing, particularly in lower bit rate encoding schemes (e.g., lower bit rate H.264/MPEG-4 encodings, etc.).

Implementations of the present disclosure can mitigate these inherent problems of chunking by using a content-adaptive algorithm. More particularly, instead of naïvely dividing a video clip into fixed-size (or approximately fixed-size) chunks, implementations of the present disclosure determine chunk boundaries based on the image content of the video clip (e.g., pixel values of frames of the video clip, features of the video clip, etc.), a minimum chunk size, and a maximum chunk size. This approach yields fewer artifacts at chunk boundaries, thereby resulting in an improved viewing experience for users.

In some implementations of the present disclosure, determining chunk boundaries based on the image content of a video clip comprises identifying scene changes in the video clip (e.g., via extraction of effects such as fade in or fade out, via pixel-based differences between frames, via histogram-based differences between frames, via statistical analysis of features, etc.). By identifying scene changes and, when possible, aligning chunk boundaries with scene changes, the quality of the stitched-together transcoded video clip is improved, as artifacts caused by chunking are generally less noticeable to viewers when coinciding with scene changes.

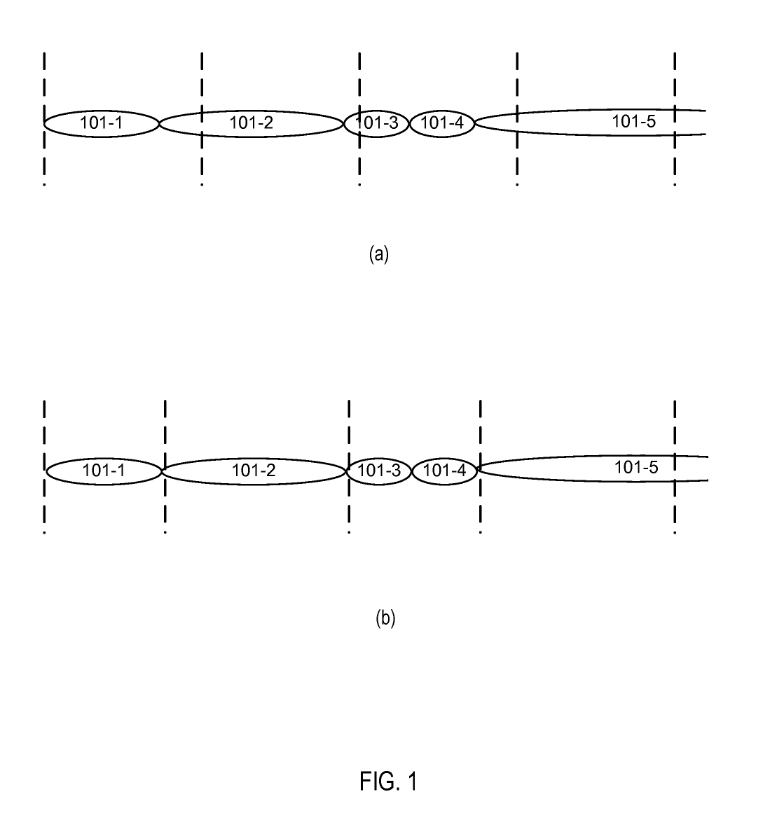

FIG. 1 depicts a portion of an illustrative video clip comprising scenes 101-1 through 101-5 divided by (a) an illustrative fixed-size chunking of the video clip, and by (b) an illustrative content-adaptive chunking of the video clip. As shown in FIG. 1, while both chunking approaches produce five chunk boundaries, the content-adaptive chunks have fewer boundaries occurring within a scene compared to the fixed-size chunking, thereby resulting in a higher-quality transcoded video clip.

In some implementations, the determination of chunk boundaries is also based on a default chunk size, in addition to minimum and maximum chunk sizes. In some such implementations, the default chunk size is greater than or equal to the minimum chunk size and less than or equal to the maximum chunk size.

In some implementations, when a scene exceeds the maximum chunk size, the splitting of the scene at a chunk boundary may be based on image content. For example, the chunk boundary may be determined based on a measure of brightness of individual frames of the scene (e.g., splitting the scene at a frame at which a measure of brightness has a minimum rate of change, etc.), or based on a measure of motion across frames of the scene (e.g., splitting the scene at a frame at which a measure of motion has a minimum rate of change, etc.).

In accordance with some implementations, a chunk may first be decoded to an intermediate “universal” format, and then transcoded from the universal format to a target encoding. Moreover, in some implementations a video clip may be transcoded into a plurality of different encodings (e.g., H.264/MPEG-4, MPEG-2, etc.). In some such implementations, each chunk is transcoded into the plurality of different encodings, and a transcoded video clip for each encoding is generated by assembling the corresponding transcoded chunks (e.g., an MPEG-2 video clip is assembled from MPEG-2-encoded chunks, an H.264/MPEG-4 video clip is assembled from H.264/MPEG-4-encoded chunks, etc.). It should be noted that in some implementations the universal format may be uncompressed, while in other implementations the universal format may be compressed.

Aspects and implementations of the present disclosure are thus capable of improving the quality of video clips that are transcoded via parallel and distributed processing. The transcoded video clips possess fewer noticeable artifacts when compared to naïve, fixed-size chunking strategies due to a reduction in intra-scene chunk boundaries, intelligent splitting of long scenes (for example, by minimizing the rate of change of brightness, motion, etc. at boundaries falling within such scenes), and an overall reduction in the number of I-frames in the transcoded video clip. Consequently, aspects and implementations of the present disclosure provide the speed advantage of transcoding video clips via distributed and parallel processing, while mitigating the reduction in quality incurred by such processing.

It should be noted that while aspects and implementations are disclosed in the context of transcoding video clips, the techniques of the present disclosure can be adapted to transcoding other types of media items (e.g., audio clips, images, etc.). For example, an analog of a scene change in a video clip might be a silent time interval in an audio clip.

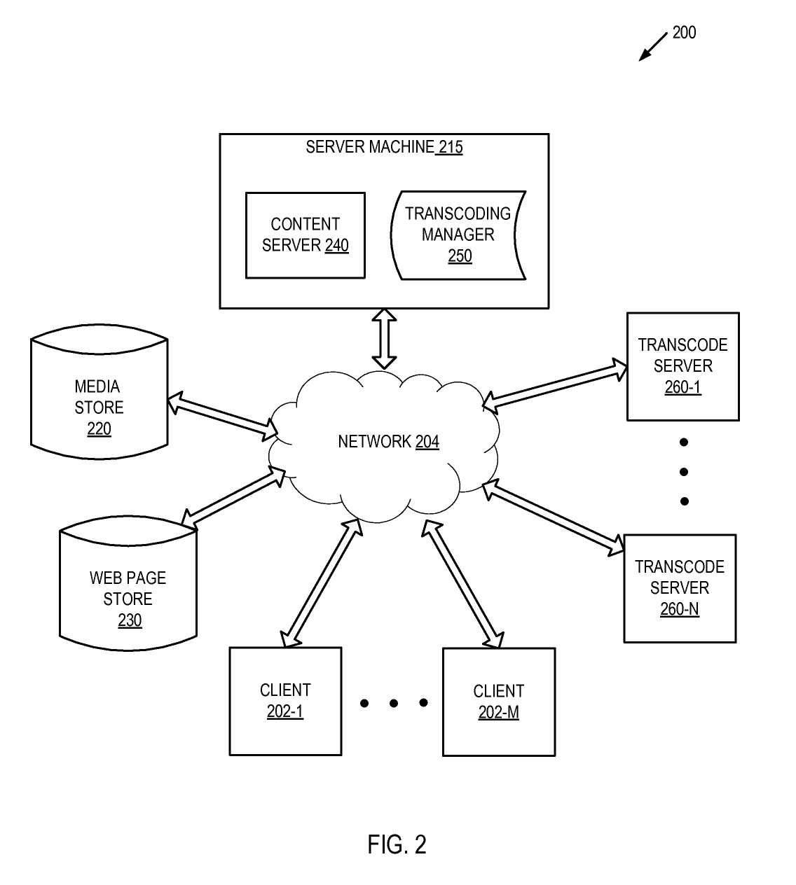

FIG. 2 illustrates an example system architecture 200, in accordance with one implementation of the present disclosure. The system architecture 200 includes a server machine 215, a media store 220, a web page store 230, client machines 202-1 through 202-M, and transcode servers 260-1 through 260-N connected to a network 204, where M and N are positive integers. Network 204 may be a public network (e.g., the Internet), a private network (e.g., a local area network (LAN) or wide area network (WAN)), or a combination thereof.

The client machines 202-1 through 202-M may be personal computers (PCs), laptops, mobile phones, tablet computers, set top boxes, televisions, video game consoles, digital assistants or any other computing devices. The client machines 202-1 through 202-M may run an operating system (not shown) that manages hardware and software of the client machines 202-1 through 202-M. A browser (not shown) may execute on some client machines (e.g., on the OS of the client machines). The browser may be a web browser that can access content served by a content server 240 of server machine 215 by navigating to web pages of the content server 240 (e.g., using the hypertext transport protocol (HTTP)). The browser may issue commands and queries to the content server 240, such as commands to upload media items (e.g., video clips, audio clips, images, etc.), search for media items, share media items, and so forth.

One or more of client machines 202-1 through 202-M may include applications that are associated with a service provided by content server 240. Examples of client machines that may use such applications (“apps”) include mobile phones, “smart” televisions, tablet computers, and so forth. The applications or apps may access content provided by content server 240, issue commands to content server 240, and so forth without visiting web pages of content server 240.

In general, functions described in one embodiment as being performed by the content server 240 can also be performed on the client machines 202-1 through 202-M in other embodiments if appropriate. In addition, the functionality attributed to a particular component can be performed by different or multiple components operating together. The content server 240 can also be accessed as a service provided to other systems or devices through appropriate application programming interfaces, and thus is not limited to use in websites.

Server machine 215 may be a rackmount server, a router computer, a personal computer, a portable digital assistant, a mobile phone, a laptop computer, a tablet computer, a camera, a video camera, a netbook, a desktop computer, a media center, or any combination of the above. Server machine 215 includes a content server 240 and a transcoding manager 250. In alternative implementations, the content server 240 and transcoding manager 250 may run on different machines.

Media store 220 is a persistent storage that is capable of storing media items (e.g., video clips, audio clips, images, etc.) as well as data structures to tag, organize, and index the media items. Media store 220 may be hosted by one or more storage devices, such as main memory, magnetic or optical storage based disks, tapes or hard drives, NAS, SAN, and so forth. In some implementations, media store 220 may be a network-attached file server, while in other embodiments media store 220 may be some other type of persistent storage such as an object-oriented database, a relational database, and so forth, that may be hosted by the server machine 215 or one or more different machines coupled to the server machine 215 via the network 204. The media items stored in the media store 220 may include user-generated media items that are uploaded by client machines, as well as media items from service providers such as news organizations, publishers, libraries and so forth. In some implementations, media store 220 may be provided by a third-party service, while in some other implementations media store 220 may be maintained by the same entity maintaining server machine 215.

Web page store 230 is a persistent storage that is capable of storing web pages and/or mobile app documents for serving to clients, as well as data structures to tag, organize, and index the web pages and/or mobile app documents (e.g., documents provided to mobile apps for rendering on mobile devices). Web page store 230 may be hosted by one or more storage devices, such as main memory, magnetic or optical storage based disks, tapes or hard drives, NAS, SAN, and so forth. In some implementations, web page store 230 may be a network-attached file server, while in other embodiments web page store 230 may be some other type of persistent storage such as an object-oriented database, a relational database, and so forth, that may be hosted by the server machine 215 or one or more different machines coupled to the server machine 215 via the network 204. The web pages and/or mobile app documents stored in the web page store 230 may have embedded content (e.g., media items stored in media store 220, media items stored elsewhere on the Internet, etc.) that is generated by users and uploaded by client machines, provided by news organizations, and so forth.

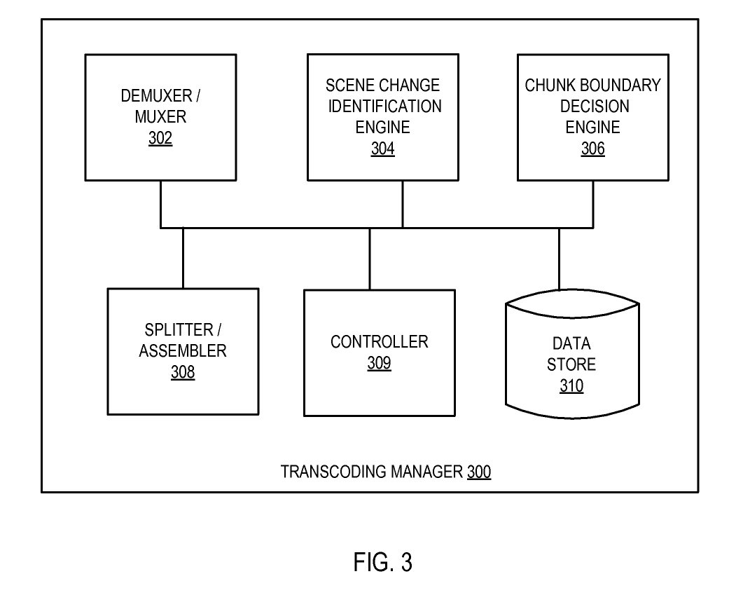

In accordance with some implementations, transcoding manager 250 is capable of storing uploaded media items in media store 220, indexing the media items in media store 220, transcoding media items as described below with respect to FIGS. 3 through 5, and performing image, video and audio processing (e.g., filtering, anti-aliasing, line detection, scene change detection, feature extraction, etc.). An implementation of transcoding manager 250 is described in detail below with respect to FIG. 3.

Each of transcode servers 260-1 through 260-N is a machine comprising a memory and one or more processors and is capable of receiving one or more chunks from server machine 215 via network 204, transcoding chunks into one or more encodings, and transmitting transcoded chunks back to server machine via network 204. It should be noted that in some alternative implementations, transcode servers 260-1 through 260-N may be connected to server machine 215 via a network other than network 204 (e.g., a local area network, a privately-owned metropolitan area network or wide-area network, etc.). It should further be noted that still other implementations might employ a parallel multi-processor machine in lieu of transcode servers 260-1 through 260-N, and that some such implementations might use the parallel multi-processor machine to perform some or all of the functions of server machine 215.

FIG. 3 is a block diagram of one implementation of a transcoding manager. The transcoding manager 300 may be the same as the transcoding manager 250 of FIG. 2 and may include a demuxer/muxer 302, a scene change identification engine 304, a chunk boundary decision engine 306, a splitter/assembler 308, a controller 309, and a data store 310. The components can be combined together or separated in further components, according to a particular implementation. It should be noted that in some implementations, various components of transcoding manager 300 may run on separate machines.

The data store 310 may be the same as media store 220, or web page store 230, or both, or may be a different data store (e.g., a temporary buffer or a permanent data store) to hold one or more media items (e.g., to be stored in media store 220, to be embedded in web pages, to be processed, etc.), one or more chunks of media items, one or more data structures for indexing media items in media store 220, one or more web pages (e.g., to be stored in web page store 230, to be served to clients, etc.), one or more data structures for indexing web pages in web page store 230, or some combination of these data. Data store 310 may be hosted by one or more storage devices, such as main memory, magnetic or optical storage based disks, tapes or hard drives, and so forth.

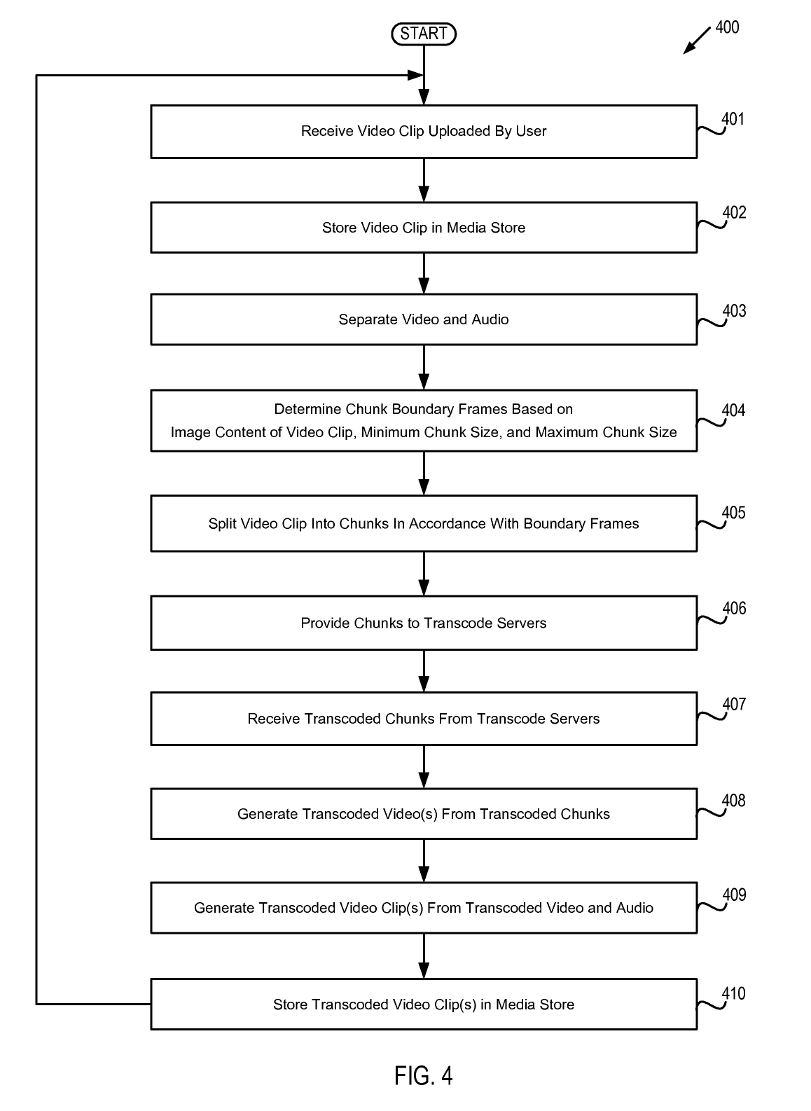

The demuxer/muxer 302 is capable of separating the video and audio portions of a video clip, and of combining video data and audio data into a video clip. Some operations of demuxer/muxer 302 are described in more detail below with respect to FIG. 4.

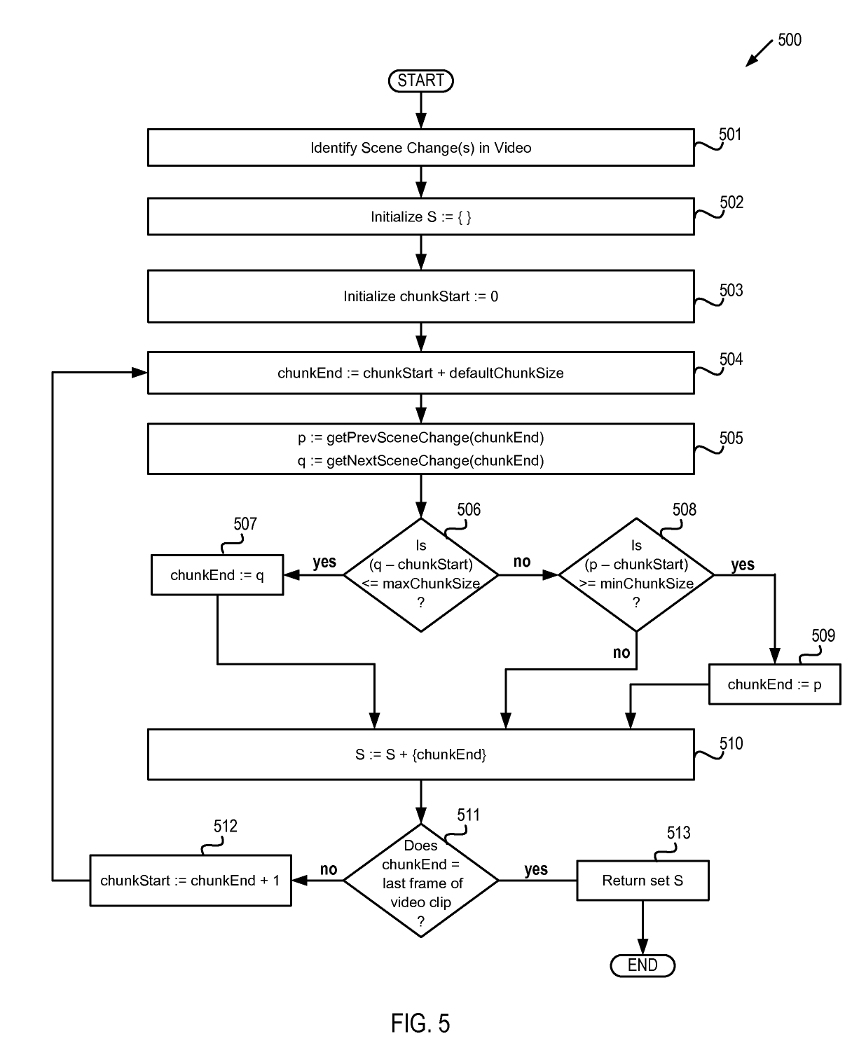

Scene change identification engine 304 is capable of identifying scene changes in a video clip (e.g., via extraction of effects such as fade in or fade out, via pixel-based differences between frames, via histogram-based differences between frames, via statistical analysis of features, etc.). Some operations of scene change identification engine 304 are described in more detail below with respect to FIG. 5.

Chunk boundary decision engine 306 is capable of determining frames of a video clip at which to divide a video clip into consecutive chunks. In one aspect, chunk boundary decision engine 306 determines the chunk boundary frames based on image content of the video clip, a minimum chunk size, and a maximum chunk size. In one implementation, the determination of chunk boundary frames is based on scene changes in the video clip, and a default chunk size in addition to the minimum and maximum chunk sizes. Some operations of chunk boundary decision engine 306 are described in more detail below with respect to FIGS. 4 and 5.

Splitter/assembler 308 is capable of splitting a video clip into consecutive chunks in accordance with a set of chunk boundary frames, and of combining chunks into a video clip. Controller 309 is capable of providing chunks to respective transcode servers 260 for transcoding, and of receiving transcoded chunks from transcode servers 260. In some implementations, controller 309 may contain logic for assigning chunks to particular transcode servers (e.g., load balancing logic, etc.). Some operations of splitter/assembler 308 and controller 309 are described in more detail below with respect to FIGS. 4 and 5.

FIG. 4 depicts a flow diagram of aspects of a method for dividing a video clip into chunks for distributed transcoding. FIG. 4 depicts a flow diagram of aspects of a method for distributed transcoding of video clips. The method is performed by processing logic that may comprise hardware (circuitry, dedicated logic, etc.), software (such as is run on a general purpose computer system or a dedicated machine), or a combination of both. In one implementation, the method is performed by the server machine 215 of FIG. 2, while in some other implementations, one or more blocks of FIG. 4 may be performed by another machine.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 401, a video clip uploaded by a user is received, and at block 402, the video clip is stored in media store 220. In accordance with one aspect, blocks 401 and 402 are performed by content server 240.

At block 403, the video and audio portions of the video clip are separated. In accordance with one aspect, block 403 is performed by demuxer/muxer 302 of transcoding manager 250.

In some implementations, the video portion of the video clip may be decoded to an intermediate “universal” format from which one or more target encodings may be obtained at blocks 406 through 408 below. In some such implementations the universal format may be uncompressed, while in some other implementations the universal format may be compressed. It should be noted that in some aspects the decoding into universal format may be performed as part of block 403, while in some other aspects the decoding may instead occur at some other point of the method of FIG. 4 (e.g., in a separate block not depicted in FIG. 4, as part of another block, such as one of blocks 404 through 410, etc.) or at some point in the method of FIG. 5, which is performed by transcode servers 260 and is described below.

At block 404, chunk boundary frames for dividing the video portion into chunks are determined based on image content of the video clip, a minimum chunk size, and a maximum chunk size. An implementation of a method for performing block 404 is described in detail below with respect to FIG. 5.

At block 405, the video clip is split into consecutive chunks in accordance with the chunk boundary frames determined at block 404. In accordance with one aspect, block 405 is performed by splitter/assembler 308 of transcoding manager 250. It should be noted that when the video clip has been decoded into an intermediate “universal” format, the chunks may be obtained by splitting the universal-format video into universal-format chunks.

At block 406, the chunks are provided to transcode servers 260 (e.g., the first chunk provided to transcode server 260-1, the second chunk provided to transcode server 260-2, etc.) for transcoding. In accordance with one aspect, block 406 is performed by controller 309 of transcoding manager 250. In some implementations, controller 309 may contain logic for assigning chunks to particular transcode servers in an intelligent manner (e.g., load balancing logic, etc.).

At block 407, transcoded chunks are received from transcode servers 260. In accordance with one aspect, block 407 is performed by controller 309. In accordance with some implementations, the chunks are transcoded in parallel by transcode servers 260, and each transcode server provides its transcoded chunk(s) to controller 309 upon completion of transcoding. It should be noted that in some implementations, transcode servers 260 may transcode each chunk into a plurality of different encodings (e.g., H.264/MPEG-4, MPEG-2, etc.), either directly or via the intermediate universal format, and provide the plurality of transcoded chunks to controller 309. It should further be noted that in some alternative implementations, the transcode servers 260 may also be responsible for decoding chunks into universal format rather than, as described above, the entire video clip being decoded into universal format prior to being split into chunks.

At block 408, one or more transcoded videos are generated from the transcoded chunks. More particularly, when the chunks are transcoded into a single encoding, a single transcoded video may be generated from the transcoded chunks; when chunks are transcoded into a plurality of encodings (e.g., universal format, MPEG-2, H.264/MPEG-4, etc.), a first transcoded video may be generated by assembling the chunks transcoded into the first encoding, a second transcoded video may be generated by assembling the chunks transcoded into the second encoding, and so forth. In accordance with one aspect, block 408 is performed by controller 309.

At block 409, a respective video clip is generated from each transcoded video generated at block 408 and from the audio obtained at block 403. In other words, in the case of a single encoding, a single transcoded video clip is generated from the audio and the transcoded video generated at block 408, while in the case of a plurality of encodings, a first transcoded video clip is generated from the audio and a first transcoded video generated at block 408, a second transcoded video clip is generated from the audio and a second transcoded video generated at block 408, and so forth. In accordance with one aspect, block 409 is performed by demuxer/muxer 302 of transcoding manager 250.

At block 410, the one or more transcoded video clips generated at block 409 are stored in media store 220. It should be noted that when the video clip has been decoded into a universal format, this version of the video clip may also be stored in media store 220. In some implementations, the universal-format video clip may be stored in media store 220 at block 410, while in some other implementations the universal-format video clip may be stored in media store 220 at an earlier point of the method (e.g., immediately following decoding into universal format at block 403 above, etc.). In accordance with one aspect, block 410 is performed by controller 309.

It should be noted that while in the flow diagram of FIG. 4 the video clips to be transcoded are uploaded by users, in some other implementations the video clips to be transcoded may be obtained in some other fashion, or may already be stored in media store 220 (e.g., a video library provided by a media company, etc.). It should further be noted that while in the flow diagram of FIG. 4 each uploaded video clip is transcoded when it is received by server machine 215, in some other implementations transcoding of uploaded video clips might instead occur at a later time (e.g., a batch job run nightly, etc.).

FIG. 5 depicts a flow diagram of aspects of a method for determining boundary frames at which to divide video into chunks. The method is performed by processing logic that may comprise hardware (circuitry, dedicated logic, etc.), software (such as is run on a general purpose computer system or a dedicated machine), or a combination of both. In one implementation, the method is performed by the server machine 215 of FIG. 2, while in some other implementations, one or more blocks of FIG. 5 may be performed by another machine. In accordance with one aspect, block 501 is performed by controller 309.

At block 501, one or more scene changes in the video are identified. In some implementations, scene change identification may comprise extraction of effects such as fade in or fade out, while in some other implementations scene change identification may comprise computing differences in pixel values between successive frames and comparing a function of the differences (e.g., the sum of the differences over all pixels, etc.) to a threshold, while in some other implementations scene change identification may comprise constructing histograms of pixel values in frames, computing differences between histograms for successive frames, and comparing a function of the differences (e.g., the sum of the differences between corresponding histogram bins, etc.) to a threshold, while in yet other implementations scene change identification may comprise a statistical analysis of features extracting from frames, while in still other implementations scene changes may be identified in some other fashion. In accordance with one aspect, block 501 is performed by scene change identification engine 304 of transcoding manager 250.

At block 502, variable S is initialized to an empty set, and at block 503, variable chunkStart is initialized to zero. At block 504, the value of variable chunkEnd is set to the sum of chunkStart and the default chunk size, defaultChunkSize. In some implementations, the default chunk size may be between the minimum chunk size and the maximum chunk size, inclusive (i.e., greater than or equal to the minimum chunk size and less than or equal to the maximum chunk size).

At block 505, variable p is set to the index of the frame of the first scene change preceding chunkEnd, and variable q is set to the index of the frame of the first scene change following chunkEnd. Block 506 compares (q−chunkStart) to the maximum chunk size, maxChunkSize; if (q−chunkStart) is less than or equal to maxChunkSize, then execution proceeds to block 507, otherwise execution continues at block 508.

At block 507, the value of variable chunkEnd is set to the value of variable q. After block 507 is performed, execution continues at block 510.

Block 508 compares (p−chunkStart) to the minimum chunk size, minChunkSize; if (p−chunkStart) is greater than or equal to minChunkSize, then execution proceeds to block 509, otherwise execution continues at block 510.

At block 509, the value of variable chunkEnd is set to the value of variable p. At block 510, the value of chunkEnd, which corresponds to a chunk boundary frame, is added to set S.

Block 511 branches based on whether variable chunkEnd equals the index of the final frame of video; if not, execution continues at block 512, otherwise execution proceeds to block 513. At block 512, the value of variable chunkStart is set to chunkEnd+1, and after block 512 is performed, execution continues back at block 504. At block 513, set S, which contains the indices of chunk boundary frames, is returned.

It should be noted that while in the implementation of FIG. 5 chunk boundary frames are defined as the last frame of a chunk, in some other implementations the chunk boundary frames may instead be defined as the first frame of a chunk, with appropriate changes made to the method of FIG. 5. Moreover, in some other implementations the determination of chunk boundary frames may be based on minimum and maximum chunk sizes, but not based on a default chunk size in addition to the minimum and maximum sizes.

It should further be noted that in some other implementations, the implementation of FIG. 5 may be modified to handle cases when a scene exceeds the maximum chunk size. In some such implementations, the splitting of a scene at a chunk boundary may be based on image content; for example, the chunk boundary may be determined based on a measure of brightness of individual frames of the scene (e.g., splitting the scene at a frame at which a measure of brightness has a minimum rate of change, etc.), or based on a measure of motion across frames of the scene (e.g., splitting the scene at a frame at which a measure of motion has a minimum rate of change, etc.), or both, while in yet other embodiments the chunk boundary of a scene exceeding the maximum size may be determined based on some other information obtained from pixel values of frames in the scene.

It should further be noted that while the implementations of FIGS. 4 and 5 are disclosed in the context of transcoding video clips, the techniques employed in these implementations can be readily adapted to transcoding other types of media items (e.g., audio clips, images, etc.). For example, an analog of frames in an audio clip might be pulse code modulated (PCM) sound samples, and an analog of a scene change in video might be a silent time interval in an audio clip.

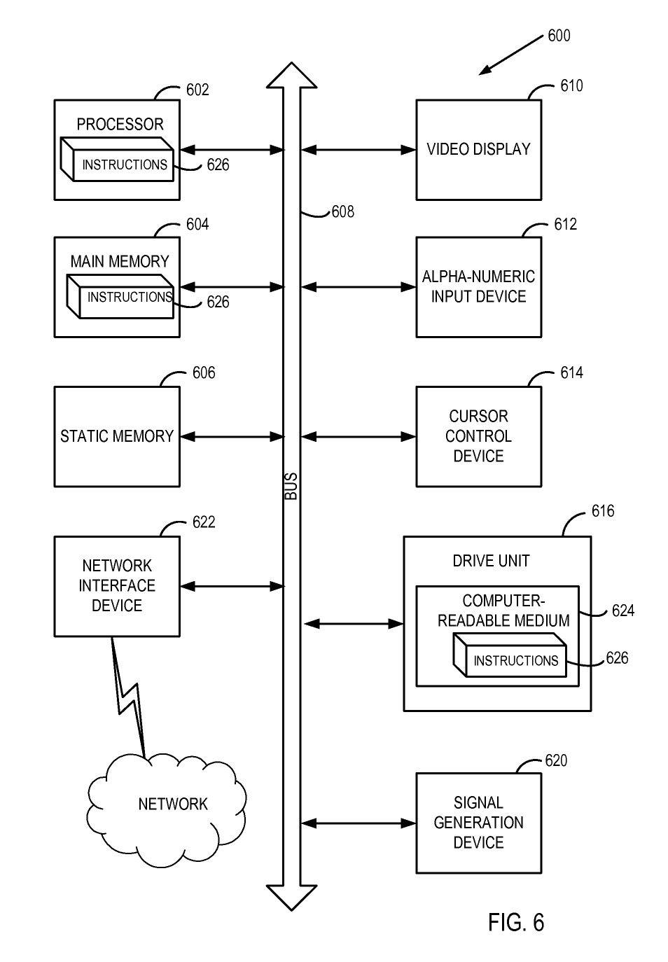

FIG. 6 illustrates an exemplary computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing system (processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 616, which communicate with each other via a bus 608.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions 626 for performing the operations and steps discussed herein.

The computer system 600 may further include a network interface device 622. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 616 may include a computer-readable medium 624 on which is stored one or more sets of instructions 626 (e.g., instructions executed by transcoding manager 225, etc.) embodying any one or more of the methodologies or functions described herein. Instructions 626 may also reside, completely or at least partially, within the main memory 604 and/or within the processor 602 during execution thereof by the computer system 600, the main memory 604 and the processor 602 also constituting computer-readable media. Instructions 626 may further be transmitted or received over a network via the network interface device 622.

While the computer-readable storage medium 624 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “providing,” “generating,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to other types of data instead of, or in addition to, media clips (e.g., images, audio clips, textual documents, web pages, etc.). The scope of the disclosure should, therefore, be determined with reference to the appended claims, along with the full scope of equivalents to which such claims are entitled.

What is claimed is:

1. A method of transcoding a video clip, the method comprising:
determining, by a computer system, N frames of the video clip at which to divide the video clip into N+1 consecutive chunks, wherein N is a positive integer, and wherein the determining is based on image content of the video clip, a minimum chunk size, and a maximum chunk size;
providing each of the N+1 chunks to a respective processor for transcoding; and
generating a transcoded video clip from the transcoded N+1 chunks.

2. The method of claim 1 wherein the determining of the N frames is further based on a default chunk size that is greater than or equal to the minimum chunk size and is less than or equal to the maximum chunk size.

3. The method of claim 1 wherein at least one of the N frames is determined based on a scene change in the video clip.

4. The method of claim 3 further comprising identifying one or more scene changes in the video clip.

5. The method of claim 1 wherein each of the respective processors is associated with a respective computer system.

6. The method of claim 1 wherein the video clip comprises a scene that exceeds the maximum chunk size, and wherein a frame within the scene is determined based on a measure of brightness for at least two frames of the scene.

7. The method of claim 6 wherein the frame occurs at a point in the scene at which the measure of brightness has a minimum rate of change.

8. An apparatus comprising:
a memory to store a video clip; and
a processor to:
determine N frames of the video clip at which to divide the video clip into N+1 consecutive chunks, wherein N is a positive integer, and wherein the determining is based on image content of the video clip, a minimum chunk size, and a maximum chunk size,
provide each of the N+1 chunks to a respective processor for transcoding to a first encoding and to a second encoding,
generate a first video clip from the N+1 chunks transcoded to the first encoding, and
generate a second video clip from the N+1 chunks transcoded to the second encoding.

9. The apparatus of claim 8 wherein the N+1 chunks are transcoded by the respective processors in parallel.

10. The apparatus of claim 8 wherein at least one of the N frames is determined based on a scene change in the video clip.

11. The apparatus of claim 10 wherein the processor is further to identify one or more scene changes in the video clip.

12. The apparatus of claim 8 wherein the determining of the N frames is further based on a default chunk size that is greater than or equal to the minimum chunk size and is less than or equal to the maximum chunk size.

13. The apparatus of claim 8 wherein the video clip comprises a scene that exceeds the maximum chunk size, and wherein a frame within the scene is determined based on a measure of motion for at least two frames of the scene.

14. The apparatus of claim 13 wherein the frame occurs at a point in the scene at which the measure of motion has a minimum rate of change.

15. A non-transitory computer-readable storage medium having instructions stored therein, which when executed, cause a computer system to perform operations comprising:
determining, by the computer system, N frames of the video clip at which to divide the video clip into N+1 consecutive chunks, wherein N is a positive integer, and wherein the determining is based on image content of the video clip, a minimum chunk size, and a maximum chunk size;
providing each of the N+1 chunks to a respective processor for transcoding; and
generating a transcoded video clip from the transcoded N+1 chunks.

16. The non-transitory computer-readable storage medium of claim 15, wherein at least one of the N frames is determined based on a scene change in the video clip.

17. The non-transitory computer-readable storage medium of claim 16, wherein the operations further comprise identifying one or more scene changes in the video clip.

18. The non-transitory computer-readable storage medium of claim 15, wherein the video clip comprises a scene that exceeds the maximum chunk size, and wherein a frame within the scene is determined based on a measure of brightness for at least two frames of the scene.

19. The non-transitory computer-readable storage medium of claim 18, wherein the frame occurs at a point in the scene at which the measure of brightness has a minimum rate of change.

20. The non-transitory computer-readable storage medium of claim 15, wherein the video clip comprises a scene that exceeds the maximum chunk size, and wherein a frame within the scene is determined based on a measure of motion for at least two frames of the scene.

21. The non-transitory computer-readable storage medium of claim 20, wherein the frame occurs at a point in the scene at which the measure of motion has a minimum rate of change.
